(19) United States
(12) Patent Application Publication
(10) Pub. No.: US 2013/0260162 A1
(43) Pub. Date: Oct. 3, 2013

(54) Paper coating slips comprising a combination of styrene-butadiene copolymer and/or styrene-acrylic ester copolymer and vinyl acetate-ethylene copolymer

(71) Applicants: Karl Ernst Fickert, Altotting (DE); Hans-Peter Weitzel, Reischach (DE)

(72) Inventors: Karl Ernst Fickert, Altotting (DE); Hans-Peter Weitzel, Reischach (DE)

(73) Assignee: Wacker Chernie AG, Munich (DE)

(21) Appl. No.: 13/824,730

(22) PCT Filed: Dec. 2, 2011
(86) PCT No.: PCT/EP11/71637

§ 371 Date: May 15, 2013

(30) Foreign Application Priority Data
Dec. 17, 2010 (DE) 102010063470.0

(51) Int. Cl. C09D 109/08; C09D 129/04; C09D 131/04; C09D 133/08

(52) U.S. Cl. CPC C09D 109/08; C09D 133/08; C09D 129/04; C09D 131/04
USPC 428/514; 524/501

(57) ABSTRACT

The invention provides paper coating slips comprising, as a binder, an aqueous dispersion of a styrene-butadiene copolymer or of a styrene-acrylic ester copolymer, or a mixture of these aqueous dispersions, characterized in that an aqueous dispersion of a polyvinyl alcohol-stabilized vinyl acetate-ethylene copolymer is additionally present in each case.

### CROSS REFERENCE TO RELATED APPLICATIONS

This application is the national phase filing of international patent application No. PCT/EP2011/071637, filed 2 Dec. 2011, and claims priority of German application number 10 2010 063 470.0, filed 17 Dec. 2010, the entireties of which applications are incorporated herein by reference.

### FIELD OF THE INVENTION

The invention relates to paper coating slips comprising as binder a combination of styrene-butadiene copolymer and/or styrene-acrylic ester copolymer with a polyvinyl alcohol-stabilized vinyl acetate-ethylene copolymer.

### BACKGROUND OF THE INVENTION

One of the moat important applications of paper and card is their function as print media. Fibrous substrates such as paper, however, possess a relatively rough surface. In order to enhance their printability, and also their quality in terms of smoothness, gloss, and, more particularly, whiteness, papers are coated with paper coating slips. Aqueous paper coating slips comprise essentially pigments, synthetic binders, further auxiliaries, and water. Binders established for paper coating slips include, in particular, copolymers based on styrene and butadiene (SBR) and based on styrene and acrylic ester. Colored paper coating slips with SBR copolymers are described in EP 666274 A2, for example. Paper coating slips with styrene-butadiene copolymers and/or styrene-acrylic ester copolymers are known from US 2005/0089643.

Disadvantages associated with the use of styrene-butadiene copolymers as binders in paper coating slips, however, include their tendency toward UV yellowing, weaknesses in the adhesive bondability of papers and cards coated with them, inadequate coat porosity of the coated print medium, absence of carrier function for fluorescent whiteners, and odor-nuisance byproducts in the copolymer. Disadvantages associated with the use of styrene-acrylate copolymers as binders in paper coating slips include inadequate wet pick resistance of the coated substrate materials (paper, card) produced with such styrene-acrylate copolymers, and the lack of carrier function for fluorescent whiteners.

In order to improve the printability of papers coated with coating compositions which comprise styrene-butadiene copolymers as binders, US 2005/0089643 A1 proposes using the styrene-butadiene copolymers in combination with styrene-acrylate copolymers.

DE-A 2107287 proposes using emulsifier-stabilized vinyl acetate-ethylene (VAE) copolymers as binders in paper coating compositions, and additionally using polyalkylene oxide compounds in order to improve the pigment binding capacity, EP 316090 B1 proposes enhancing the binding power of emulsifier-stabilized vinyl acetate copolymers in paper coatings by using a specific emulsifier combination in the course of their production. U.S. Pat. No. 6,153,288 discloses increasing the binder quality of vinyl acetate-ethylene copolymers in paper coatings through combination with cationic polymers. DE 3522820 A1 discloses using polyvinyl alcohols as carrier material for fluorescent whiteners in coating slips.

### SUMMARY OF THE INVENTION

Against this background, the object was to improve paper coating compositions comprising, as binders, styrene-butadiene copolymers and/or styrene-acrylic ester copolymers with regard to their above-described disadvantages such as tendency toward UV yellowing, weaknesses in the adhesive bondability of papers coated therewith, inadequate coat porosity, and, in particular, the whiteness of the coated print media.

This has been achieved, surprisingly, through combination with binder based on polyvinyl alcohol-stabilized vinyl acetate-ethylene copolymers, without obtaining the anticipated loss of binding power due to the VAE fraction. Polyvinyl alcohol-stabilized vinyl acetate-ethylene copolymers have not hitherto been used as a component of paper coating slips.

### DETAILED DESCRIPTION OF THE INVENTION

The invention provides paper coating slips comprising as binder an aqueous dispersion of a styrene-butadiene copolymer or of a styrene-acrylic ester copolymer, or a mixture of these aqueous dispersions, characterized in that in each case additionally an aqueous dispersion of a vinyl acetate-ethylene copolymer stabilized with polyvinyl alcohol is comprised.

Suitable aqueous dispersions of styrene-butadiene copolymers and processes for preparing them are known to the skilled person, from EP 656274 A2, for example. Such dispersions are also available commercially. The copolymers contain in general 50% to 80% by weight of styrene, 20% to 50% by weight of butadiene, and 0% to 10% by weight of one or more ethylenically unsaturated, functional comonomers, with the figures in % by weight adding up to 100% by weight in each case.

Suitable aqueous dispersions or styrene-acrylic ester copolymers and processes for preparing them are known to the skilled person. The copolymers contain in general 50% to 80% by weight or styrene, 20% to 50% by weight of one or more acrylic esters of alcohols having 1 to 18 C atoms, preferably methyl acrylate, ethyl acrylate, propyl acrylate, butyl acrylate, 2-ethylhexyl acrylate, optionally in a mixture with methacrylic ester such as methyl methacrylate, and 0% to 10% by weight of one or more ethylenically unsaturated, functional comonomers, with the figures in % by weight adding up to 100% by weight in each case.

Examples of ethylenically unsaturated, functional comonomers are ethylenically unsaturated carboxylic acids or salts thereof, such as acrylic acid or methacrylic acid, ethylenically unsaturated sulfonic acids or salts thereof seen as vinyl sulfonate, ethylenically unsaturated carboxamides such as acrylamide or methacrylamide, and ethylenically unsaturated nitriles such as acrylonitrile. The solids content of the aqueous dispersions of styrene-butadiene copolymers or styrene-acrylic ester copolymers is generally 40% to 10% by weight.

The aqueous styrene-butadiene copolymer dispersions or styrene-acrylic ester copolymer dispersions are prepared in a known way by radically initiated emulsion polymerization in the presence of radical initiators and emulsifiers and optionally of further auxiliaries such as polymerization chain-transfer agents. Suitable styrene-butadiene copolymer dispersions and styrene-acrylic ester copolymer dispersions are available commercially.

Suitable aqueous dispersions of polyvinyl alcohol-stabilized vinyl acetate-ethylene copolymers and processes for preparing them are known to the skilled person, from EP 1352915 B1, for example. Such dispersions are available commercially.

The vinyl acetate-ethylene copolymers contain generally 1% to 40% by weight, preferably 5% to 30% by weight, of ethylene, 40% to 99% by weight of vinyl acetate, 0% to 50% by weight of further comonomers from the group of vinyl esters and (meth)acrylic esters, 0% to 5% by weight of ethylenically unsaturated functional comonomers, the figures in % by weight adding up to 100% by weight in each case.

Suitable further vinyl esters are those of carboxylic acids having 3 to 12 C atoms, such as vinyl propionate, vinyl butyrate, vinyl 2-ethylhexanoate, vinyl laurate, 1-methylvinyl acetate, vinyl pivalate, and vinyl esters of α-branched monocarboxylic acids having 9 to 11 C atoms, as for example VeoVa9® or VeoVa10® (trade names of Hexion). Suitable methacrylic esters or acrylic esters are esters of unbranched or branched alcohols having 1 to 18 C atoms, such as methyl acrylate, methyl methacrylate, n-butyl acrylate, and 2-ethylhexyl acrylate.

Examples of ethylenically unsaturated, functional comonomers are ethylenically unsaturated monocarboxylic and dicarboxylic acids, preferably acrylic acid, methacrylic acid, fumaric acid, and maleic acid; ethylenically unsaturated carboxamides and, carbonitriles, preferably acrylamide and acrylonitrile; monoesters and diesters of fumaric acid and maleic acid such as the diethyl and diisopropyl esters, and also maleic anhydride, ethylenically unsaturated sulfonic acids and/or salts thereof, preferably vinylsulfonic acid, 2-acrylamido-2-methylpropanesulfonic acid. Other examples are precrosslinking comonomers such as polyethylenically unsaturated comonomers, examples being divinyl adipate or triallyl cyanurate, or postcrosslinking comonomers, an example being N-methylolacryiamide (NMA). Also suitable are epoxy-functional comonomers such as glycidyl methacrylate. Other examples are silicon-functional comonomers, such as methacryloyloxypropyltri(alkoxy)silanes, vinyltrialkoxysilanes, and vinylmethyldialkoxysilanes, where methoxy radicals, ethoxy radicals may be present, for example, as alkoxy groups.

Preference is given to copolymers of vinyl acetate with 1% to 40% by weight of ethylene; and also

copolymers of vinyl acetate with 1% to 40% by weight of ethylene and 1% to 50% by weight of one or more further comonomers from the group of vinyl esters having 3 to 12 C atoms in the carboxylic acid residue, such as vinyl propionate, vinyl laurate, vinyl esters of alpha-branched carboxylic acids having 9 to 11 C atoms such as VeoVa9, VeoVa10, VeoVa11; and
copolymers of vinyl acetate, 1% to 40% by weight of ethylene, and preferably 1% to 50% by weight of (meth)acrylic esters of unbranched or branched alcohols having 1 to 18 C atoms; the copolymers may further comprise the stated functional comonomers in the stated amounts, and the figures in % by weight add up to 100% by weight in each case.

The polyvinyl alcohol-stabilized vinyl acetate-ethylene copolymers are prepared by the emulsion polymerization process, with the polymerization temperature being generally 60° C. to 90° C. The polymerization is initiated with the initiators customary for emulsion polymerization. In order to control the molecular weight it is possible to use substances that have a chain-transfer activity during the polymerization.

The polyvinyl alcohol fraction is preferably added before or during the emulsion polymerization, and stabilizes the dispersion as it forms. It is preferred to use partially hydrolyzed polyvinyl alcohol as a protective colloid. Particularly preferred are partially hydrolyzed polyvinyl alcohols having a degree of hydrolysis of 80 to 95 mol % and a Höppler viscosity in 4% strength aqueous solution of 4 to 30 mPas (Höppler method at 20° C., DIN 53015). The most preferred are polyvinyl alcohols having a degree of hydrolysis of 85 to 90 mol % and a Höppler viscosity in 4% strength aqueous solution of 4 so 30 mPas (Höppler method at 20° C., DIN 53015). The stated protective colloids are available commercially and/or obtainable by means of methods known to the skilled person.

The polyvinyl alcohols are generally added in an amount of in total 1% to 20% by weight, based on the total weight of the monomers, in the polymerization. The vinyl acetate ethylene copolymer dispersions contain generally 1% to 20% by weight of polyvinyl alcohol, preferably 5% to 10% by weight, based in each case on vinyl acetate-ethylene copolymer. The solids content of the dispersions is generally 30% to 70% by weight, preferably 50% to 65% by weight.

Besides polyvinyl alcohol, there may also be other protective colloids, optionally, present in the aqueous dispersion of the vinyl acetate-ethylene copolymer. Examples of such further protective colloids are polysaccharides such as starches or dextrins, celluloses and cellulose ethers, synthetic polymers such as poly(meth)acrylic acid. The aqueous dispersion of the vinyl acetate-ethylene copolymer preferably contains no emulsifier.

The paper coating slips preferably comprise at least one aqueous dispersion of a styrene-butadiene copolymer, or at least one aqueous dispersion of a styrene-acrylic ester copolymer, or a mixture of at least one aqueous dispersion of a styrene-butadiene copolymer and of at least one aqueous dispersion of a styrene-acrylic ester copolymer, in each case in combination with at least one aqueous dispersion of a vinyl acetate-ethylene copolymer stabilized with polyvinyl alcohol, preferably in a weight ratio of the styrene-containing copolymers to the vinyl acetate-ethylene copolymers of in each case 50:50 to 95:5, preferably 75:25 to 95:5 (solid/solid).

The formulas of paper coating slips are known. The fraction of the formula constituents in paper coating slips is based below on the pigment fraction. Examples of suitable pigments include clays, calcium carbonate, titanium oxide. Preference is given to kaolin and/or calcium carbonate. The binder fraction—that is, in the present case, the fraction of the mixture of aqueous dispersion of a styrene-butadiene copolymer and/or of a styrene-acrylic aster copolymer, and aqueous dispersion of a polyvinyl alcohol-stabilized vinyl acetate-ethylene copolymer—is generally 7 to 20 parts by weight (solid) based on 100 parts by weight of pigment (solid).

Other constituents of the formula are further adjuvants from the group of the dispersants such as sodium polyacrylates, the lubricants such as fatty acid salts (e.g., stearates), the fluorescent whiteners such as diaminostilbenedisulfonic acid derivatives, co-binders, defoamers, preservatives, and water. For producing the paper coating slips, the pigment fraction, generally in the form of an aqueous pigment slurry, the binder fraction, and also the further adjuvants are mixed with water in a manner known to the skilled person.

Application of the paper coating slip to the respective substrates takes place with the coating equipment customary for this purpose, such as, for example, knife-coating units, roll-coating units, and blade-coating units. Suitable substrate materials are paper and card.

The paper coating slips equipped in accordance with the invention are used preferably for producing coated graphics papers or coated graphics card.

The advantages of the present invention are elucidated in the examples and tests below, without these examples and tests constituting any restriction.

### EXAMPLE 1

Preparation of the polyvinyl alcohol-stabilized vinyl acetate-ethylene copolymer dispersion:

A pressure reactor was charged with 95.5 kg of a polyvinyl alcohol (20% strength solution in water) having a Höppler viscosity in a 4% strength by weight solution of 4 mPas and having a degree of hydrolysis of 88 mol %. Also included in the initial charge were 224 kg of vinyl acetate and 101.5 kg of deionized water. The reactor was brought to a pressure of 21 bar and a temperature of 55° C. (corresponding to an amount of ethylene of 18.5 kg) and the polymerization was initiated by commencement of the initiator feeds of tert-butyl hydroperoxide (3% by weight in water) and ascorbic acid (5% by weight in water) each at 750 g/h. At onset of reaction, discernible from a rise in temperature, the reaction temperature was raised, with the aid of the heat of polymerization given off, to 90° C., and the pressure to 44 bar. The initiator feeds were reduced each to 350 g/h. 45 minutes after reaction onset, additional feeds were commenced: 40 kg/h vinyl acetate for a time of 90 minutes (corresponding to 60 kg of vinyl acetate) and 22 kg/h of a 10.6% strength by weight aqueous polyvinyl alcohol solution, having a Höppler viscosity in a 4% strength by weight solution of 4mPas, and a degree of hydrolysis of 88 mol %, for a time of 120 minutes (corresponding to an amount of 44 kg). Ethylene was topped up for a target pressure of 44 bar, up to a total amount of ethylene of 34 kg. After the end of the feeds, the initiator feeds were continued for 30 minutes more at 1300 g/h, during which the pressure dropped to 20 bar. The batch was subsequently cooled to 65° C. and transferred to an unpressurized reactor, where polymerization was continued under a pressure of 700 mbar through addition of 1 kg of tert-butyl hydroperoxide (10% by weight in water) and 2 kg of ascorbic acid (5% by weight in water). The completed dispersion was filtered through a sieve having a mesh size of 65 μm and discharged.

The dispersion obtained had a solids content of 60.3% by weight, a viscosity of 2850 mPas (Brookfield, 20, 23° C.), a glass transition temperature of 15.0° C. The average of the weight-average particle size distribution Dw of the dispersion was 1050 nm (specific surface area: 6.3 m²/g).

The coating slip formulas used in the tests below contained the following materials:

| Product | Description | Manufacturer |
|---|---|---|
| Hydrocarb 90 | Pigment: Calcium carbonate, | Omya, Cologne |
| | 90% < 2 μm | |
| Camcoat 80 | Pigment: Coating-grade | AKW, Hirschau |
| | kaolin, 80% < 2 μm | |
| Sterocoll FS | Alkaline acrylate copolymer | BASF |
| | thickener | |
| Litex P 7110 | Styrene-butadiene copolymer | Polymer Latex |
| | dispersion | |
| Primal P-308M | Styrene-acrylic ester | Rohm + Haas |
| | copolymer dispersion | |
| Tinopal ABP-Z | Tetrasulfo brightener | BASF |
| | (stilbene derivative) | |
| Optiblanc NL | Disulfo brightener (stilbene | 3-Sigma |
| | derivative) | |
| VAE dispersion | Dispersion from example 1 | Wacker Chemie |

For the production of the coating slip, the constituents of the formula were mixed with a laboratory stirrer and adjusted to the respective solids content by dilution with water. The viscosity of the coating slips was subsequently determined using a Brookfield viscometer (spindle 4, 100 rpm, 20° C.).

For testing, the coating slip was applied to the respective substrate material.

A first substrate used was glass fiber paper having a basis weight of 75 g/m² (Ref. No. 10370050 from Schleicher&Schüll). Application took place using a 30 μm four-way film-drawing applicator; the coat weight was 15 g/m².

Testing additionally took place on duplex card (chromo-duplex card, basis weight 350 g/m²). Application here took place using a 20 μm four-way film-drawing applicator; the coat weight was 20 g/m².

The test parameters ascertained for the purpose of testing, along with the measurement methods and testing instruments employed, are compiled below:

| | Standard/measurement | |
|---|---|---|
| Test parameter | method | Testing instrument |
| Viscosity | Spindle 4, 100 rpm | Brookfield |
| | | viscometer |
| Whiteness R 457 | Tappi, Filter R457 | Elrephomat 450X, |
| | | illuminant D65 |
| CIE whiteness | ISO 2470 | Elrephomat 450X, |
| | | illuminant D65 |
| Yellow index after | DIN 5033 | Elrephomat 450X, |
| UV yellowing | Part 2, 3, 7 | illuminant D65 |
| Ink absorption test | Prüfbau | Prüfbau multi- |
| | | purpose proof |
| | | printing machine |
| Color density | ISO 13656 | X-rite spectro- |
| measurement | | photometer, |
| | | SpectroEye |
| UV yellowing | — | UV-A lamp with |
| | | 351 nm, based on |
| | | DIN 6167 |

Determination of the viscosity of inventively modified coating slips with a styrene-butadiene dispersion and a VAE dispersion

The coating slips were produced using the coating formula indicated in each case in table 1. The solids content of the coating slips was selected such that in the comparative example (state of the art) without fluorescent whiteners the Brookfield viscosity attained at 100 rpm and 20° C. was approximately 1100 mPa.s, corresponding to a common practice coating slip for processing on a blade-coating assembly. The associated results are likewise summarized in table 1.

TABLE 1
Viscosity of the modified coating slips

| | Comparative | +VAE | Comparative | +VAE | Comparative | +VAE |
|---|---|---|---|---|---|---|
| | Figures in parts by weight, solid | | | | | |
| Coating | | | | | | |
| formula | | | | | | |
| Hydrocarb 90 | 80 | 80 | 80 | 80 | 80 | 80 |
| Camcoat 80 | 20 | 20 | 20 | 20 | 20 | 20 |
| Sterocoll FS | 0.13 | 0.13 | 0.13 | 0.13 | 0.13 | 0.13 |
| Litex P 7110 | 14 | 10.5 | 14 | 10.5 | 14 | 10.5 |
| VAE | | 3.5 | | 3.5 | | 3.5 |
| dispersion | | | | | | |
| Tinopal ABP-Z | | | 1 | 1 | | |
| Optiblanc NL | | | | | 1 | 1 |
| | Colored coating slip values | | | | | |
| Test | | | | | | |
| parameter | | | | | | |
| Solids | 65 | 65 | 65 | 65 | 65 | 65 |
| concent % by | | | | | | |
| weight | | | | | | |
| Viscosity | 1050 | 820 | 1116 | 490 | 910 | 560 |
| MPa · s | | | | | | |
| Solids | | | | 70 * | | 69 * |
| concent % by | | | | | | |
| weight | | | | | | |
| Viscosity | | | | 1100 | | 990 |
| MPa · s | | | | | | |

Surprisingly it was sound that coating slips which as well as the SBR dispersion also include the inventive fractions of the VAE dispersion, in comparison to the coating slip without a fraction of VAE dispersion, exhibit a substantially lower viscosity for a comparable solids content. This effect is even more pronounced when fluorescent whiteners are present in the coating slip formula. The lower viscosity is evidently not dependent on the type of brightener (disulfo/Optiblanc NL or tetrasulfo/Tinopal ABP-Z). In coating slips which comprise the inventive combination plus a fluorescent whitener, this enables a considerable increase in the solids content (lower addition of water necessary; see (*) penultimate and last lines in table 1). This leads to potentially higher machine speeds, since the amount of water to be dried in the coating slip is less, and also to better coating values, since in the course of its application the coating slip penetrates less into the raw material, resulting in better “coat holdout”, and resulting in turn in an improvement in the coat properties and, ultimately, better reproduction of the printed image. Taking as a yardstick the viscosity of the respective comparative coating slips without the inventive combination, table 1 shows that in the selected coating slip formula with the inventive combination, increases in solids content of 4-5% points are possible for a comparable viscosity.

Determination of the viscosity of inventively modified coating slips with a styrene-acrylic ester copolymer dispersion and a VAE dispersion

The coating slips were produced using the coating formula indicated in each case in table 1a. The solids content of the coating slips was selected such that in the comparative example (state of the art) without fluorescent whiteners the Brookfield viscosity attained at 100 rpm and 20° C. was approximately 800 mPa.s, corresponding to a common practice coating slip for processing on a knife-coating assembly. The associated results are likewise summarized in table 1a.

TABLE 1a
Viscosity of the modified coating slips

| | Figures in parts by weight, solid | | | |
|---|---|---|---|---|
| Coating formula | Comparative | +VAE | Comparative | +VAE |
| Hydrocarb 90 | 80 | 80 | 80 | 80 |
| Camcoat 80 | 20 | 20 | 20 | 20 |
| Sterocoll FS | 0.13 | 0.13 | 0.13 | 0.13 |
| Primal P-308M | 14 | 10.5 | 14 | 10.5 |
| VAE dispersion | | 3.5 | | 3.5 |
| Tinopal ABP-Z | | | 1 | 1 |
| Test parameter | Colored coating slip values | | | |
| Solids content | 68 | 68 | 68 | 68 |
| % by weight | | | | |
| Viscosity mPa · s | 810 | 790 | 1004 | 590 |

It was found that coating slips which as well as the styrene-acrylic ester copolymer also comprise the inventive fractions of VAE dispersion, in comparison to the coating slip without a fraction of VAE dispersion, exhibit a comparable viscosity for a comparable solids content. If, however, fluorescent whitener is added to both ceasing slips, then the coating slip with the inventive fractions of VAE dispersion exhibits a substantially lower viscosity tor comparable solids content. This opens up in turn a possible increase in solids content, associated with the advantages as described in the example of table 1.

Determination of the coat reflection values of coated substrate materials produced with the inventively modified coating slips wish a styrene-butadiene dispersion and VAE dispersion:

The coating slips were produced with the coat formula indicated in each case in table 2, with a solids content of 65% by weight, were applied to glass fiber paper by means of a 30 μm four-way film-drawing applicator, corresponding to a coat thickness of 10-12 μm, and were dried in a forced-air drying cabinet at 100° C. for one minute. The substrate material used for the coaxing slips was, deliberately, neutral glass fiber paper, in order to be able to rule out any effect of the uncoated paper/uncoated card, such as that of a fluorescent whiteness for example, on the results. The resultant coating specimens were used for measurement of the reflection values customary within the paper industry, of R457 whiteness and CIE whiteness. The formulas and the associated results are summarized in table 2.

TABLE 2
Coat reflection values

| | Figures in parts by weight, solid | | |
|---|---|---|---|
| Coat formula | Comparative | +VAE | +VAE |
| Hydrocarb 90 | 80 | 80 | 80 |
| Camcoat 80 | 20 | 20 | 20 |
| Sterocoll FS | 0.13 | 0.13 | 0.13 |
| Litex P7110 | 14 | 10.5 | 7 |
| VAE dispersion | | 3.5 | 7 |
| Tinopal ABP-Z | 1 | 1 | 1 |
| Test parameter | Reflection values | | |
| R 457 whiteness % | 90.2 | 95.1 | 98.6 |
| Increase in R 457 | | +5.4% | +9.3% |
| whiteness | | | |
| CIE whiteness | 81.2 | 96.7 | 107.1 |
| Increase in CIE whiteness | | +19% | +32% |

Relative to the comparative coat only with the binder based on styrene-butadiene, the coats with an increasing fraction of the VAE dispersion exhibited a significant increase in the practice-relevant reflection parameters of R457 whiteness and CIE whiteness. In practice, significance with regard to the R457 values is understood to be a deviation by ±1 whiteness percentage point, and by ±3 CIE whiteness points for the CIE values.

Expressed in percent, depending on the fraction of VAE dispersion, it is possible to achieve an increase of up to 9.3% in the R457 whiteness values and of up to 31% in the case of the CIE values.

The increase in the reflection values can be attributed to she respective fraction of the inventive VAE dispersion in the coat, with its protective colloid system based on polyvinyl alcohol, which acts as an acceptor for the fluorescent whitener.

Determination of the coat reflection values of coated substrate materials produced with the inventively modified coating slips with a styrene-acrylic ester copolymer dispersion and VAE dispersion:

The coating slips were produced with the coat formula indicated in each case in table 2a, with a solids content of 68% by weight, were applied to glass fiber paper by means of a 30 μm four-way film-drawing applicator, corresponding to a coat thickness of approximately 12 μm, and were dried in a forced-air drying cabinet at 100° C. for one minute. The substrate material used for the coating slips was, deliberately, neutral glass fiber paper, in order to be able to rule out any effect of the uncoated paper/uncoated card, such as that of a fluorescent whitener, for example, on the results. The resultant coating specimens were used for measurement of the reflection values customary within the paper industry, of R457 whiteness and CIE whiteness. The formulas and the associated results are summarized in table 2a.

TABLE 2a
Coat reflection values

| | Figures in parts by weight, solid | | |
|---|---|---|---|
| Coat formula | Comparative | +VAE | +VAE |
| Hydrocarb 90 | 80 | 80 | 80 |
| Camcoat 80 | 20 | 20 | 20 |
| Sterocoll FS | 0.13 | 0.13 | 0.13 |
| Primal P-308M | 14 | 10.5 | 7 |
| VAE dispersion | | 3.5 | 7 |
| Tinopal ABP-Z | 1 | 1 | 1 |
| Test parameter | Reflection values | | |
| R 457 whiteness % | 92.3 | 96.2 | 98.3 |
| Increase in R 457 | | +4.2% | +6.5% |
| whiteness | | | |
| CIE whiteness | 87.7 | 100.1 | 106.3 |
| Increase in CIE whiteness | | +14% | +21% |

Relative to the comparative coating only with the binder based on styrene-acrylic ester copolymer, the coats with an increasing fraction of the VAE dispersion exhibited a significant increase in the practice-relevant reflection parameters of R457 whiteness and CIE whiteness. Expressed in percent, depending on the fraction of VAE dispersion, an increase of up to 6.5% in the R457 whiteness values and of up to 21% in the case of the CIE values can be achieved. The increase in the reflection values can be attributed to the respective fraction of the VAE dispersion in the coat with its protective colloid system, based on polyvinyl alcohol, which acts as an acceptor for the fluorescent whitener.

Determination of the UV coat yellowing of coated substrate materials produced with the inventively modified coating slips, with a styrene-butadiene dispersion and VAE dispersion:

The coated papers were produced as described for the determination of the coat reflection values. The substrate material used for the coating slips was neutral glass fiber paper, in order to be able to rule out any influence of the uncoated paper/uncoated card, such as that of a fluorescent whitener, for example, on the results.

The coating slips deliberately contained no fluorescent whitener, since such whitener would falsify the outcome with regard to the UV yellowing of the coats, for the reason that fluorescent whiteners, on account of their chemical constitution, decompose under UV light and so cause the coats first to yellow strongly and then, over time, to fade.

Coated papers and cards which are intended for prolonged use, such as calendars, pictures, posters or packaging, for example, and which are exposed to daylight, therefore contain no fluorescent whiteners in the coat.

The yellowing of the resultant coat specimens was measured after the coat specimens had been exposed for 27 hours to a UV lamp with a wavelength of 351 nm, with 27 hours of irradiation corresponding in practice to about 20 days of daylight (according to manufacturer figures). The formulas and the associated results are summarized in table 3.

TABLE 3
Coat yellowing

| | | | Parts by weight, solid | | |
|---|---|---|---|---|---|
| Coat formula | | | Comparative | +VAE | +VAE |
| Hydrocarb 90 | | | 80 | 80 | 80 |
| Camcoat 80 | | | 20 | 20 | 20 |
| Sterocoll FS | | | 0.13 | 0.13 | 0.13 |
| Litex P7110 | | | 14 | 10.5 | 7 |
| VAE dispersion | | | 3.5 | 7 | |
| Test parameter | | | Reflection values | | |
| R 457 whiteness | % | before UV | 88.3 | 89.0 | 89.8 |
| | | irradiation | | | |
| R 457 whiteness | % | after 20 days' | 85.0 | 87.0 | 88.1 |
| | | UV irradiation | | | |
| Loss of | %-points | | −3.3 | −2 | −1.7 |
| whiteness | | | | | |
| yellow index | | before UV | 4.4 | 3.8 | 2.8 |
| | | irradiation | | | |
| yellow index | | after 20 days' | 8.2 | 6.2 | 5 |
| | | UV irradiation | | | |
| Loss of yellow | %-points | | 3.8 | 2.4 | 2.2 |
| index | | | | | |

The coats without whitener, with the inventive combination, initially exhibited a higher whiteness than the comparative coat with exclusively styrene-butadiene dispersion. This difference can also be seen clearly in the yellow index (the lower the numerical value, the higher the whiteness). Hence it is also demonstrated that through the use of the inventive combination, even without a fluorescent whitener fraction, the coat whiteness achieved is already higher in the coat. The coats with an increasing fraction of VAE dispersion in the inventive combination, relative to the comparative coat with the binder exclusively based on styrene-butadiene copolymer, exhibited a substantially lower drop in whiteness over time, and are therefore more stable to UV light. If the yellow index is taken as a numerical measure of the yellowing, then here again the difference in the loss in whiteness and in the yellowing is clearly perceptible.

### Determination of the Ink Absorption of Coated Card

The absorption is related to the absorbency of a coated paper or card for the printing ink. The intensity of the absorption is determined by the time of penetration into the respective coat. For offset printing, this property is very important, since excessively slow absorption may cause ink deposition in the stack and also a build up of ink on the rubber blanket of the offset printing machine, and this may lead to frequent stoppages of the printing machine, owing to required washing intervals. The absorption behavior of coated paper or card is determined by means of proof printers. In the example case, this was done using the Prüfbäu multi-purpose proof printing machine.

A test strip of the coated paper or card was printed with a defined amount of printing ink and then counter-printed at defined time intervals—in the example case after 15/30/60/120 seconds—against a standardized, unprinted paper. In the normal case, the counter prints show a decreasing color density on account of the process of absorption and the drying of the printing ink. The shorter the time from an intensely colored counter print to a colorless counter print, the more rapid the ink absorption.

The ink absorption can be assessed visually or numerically with the color density measurement, in the example case, color density measurement was selected.

The coating slips were produced according to a practice-customary colored coating slip formula, as shown in the table, in the laboratory, with a solids content of 65% by weight, and were applied to chromoduplex card using a 20 μm wire doctor, and the cards coated accordingly were dried in a forced-air drying cabinet at 100° C. for one minute. The coat weight was approximately 20 g/m².

The cards thus coated were subjected to the ink absorption test outlined above, and the counter print strips were evaluated by color density measurement.

The formulas and the associated results are summarized in table 4 (styrene-butadiene copolymer+VAE dispersion) and table 4a (styrene-acrylic ester copolymer+VAE dispersion).

TABLE 4
Ink absorption

| | Figures in parts by weight, solid | | |
|---|---|---|---|
| Coat formula | Comparative | +VAE | +VAE |
| Hydrocarb 90 | 80 | 80 | 80 |
| Camcoat 80 | 20 | 20 | 20 |
| Sterocoll FS | 0.13 | 0.13 | 0.13 |
| Litex P7110 | 14 | 10.5 | 7 |
| VAE dispersion | 0 | 3.5 | 7 |
| Tinopal ABP-Z liq. | 1 | 1 | 1 |
| Test parameter | Color density value | | |
| Counter after 15 s | 0.14 | 0.11 | 0.08 |
| Counter after 30 s | 0.05 | 0.03 | 0.03 |
| Counter after 60 s | 0.03 | 0.02 | 0.02 |
| Counter after 120 s | 0.02 | 0.02 | 0.02 |

TABLE 4a
Ink absorption

| | Figures in parts by weight, solid | | |
|---|---|---|---|
| Coat formula | Comparative | +VAE | +VAE |
| Hydrocarb 90 | 80 | 80 | 80 |
| Camcoat 80 | 20 | 20 | 20 |
| Sterocoll FS | 0.13 | 0.13 | 0.13 |
| Primal P-308M | 14 | 10.5 | 7 |
| VAE dispersion | 0 | 3.5 | 7 |
| Tinopal ABP-Z liq. | 1 | 1 | 1 |
| Test parameter | Color density value | | |
| Counter after 15 s | 0.19 | 0.12 | 0.04 |
| Counter after 30 s | 0.15 | 0.08 | 0.02 |
| Counter after 60 s | 0.08 | 0.05 | 0.02 |
| Counter after 120 s | 0.03 | 0.02 | 0.02 |

The color density values after 15 and 30 seconds showed a significantly more rapid ink absorption by the more porous coats with the inventive combination, relative to the more impervious comparative coats wish the binders exclusively based on styrene-butadiene copolymer or styrene-acrylic ester copolymer, each of which slows down the penetration of printing ink.

In addition to the advantages just discussed, the paper coating slips composed in accordance with the invention have the advantage that the use of dissolved polyvinyl alcohol granules, which must first be prepared, in a costly and inconvenient procedure, in a polyvinyl alcohol boiler, is unnecessary, since the polyvinyl alcohol fraction is already introduced via the polyvinyl alcohol-stabilized VAE dispersion. Should the polyvinyl alcohol fraction introduced into the coating slip via the polyvinyl alcohol-stabilized VAE dispersion not be sufficient as an acceptor, then the amount of polyvinyl alcohol, dissolved in a costly and inconvenient procedure beforehand, that has to be added is substantially less than would be necessary in a coating slip without the VAE dispersion of the invention, and this, additionally, brings a considerable economic advantage.

1. A paper coating slip comprising as binder an aqueous dispersion of a styrene-butadiene copolymer or of a styrene-acrylic ester copolymer, or a mixture of these aqueous dispersions, wherein in each case additionally an aqueous dispersion of a vinyl acetate-ethylene copolymer stabilized with polyvinyl alcohol is included.

2. The paper coating slip of claim 1, wherein the aqueous dispersion or the vinyl acetate-ethylene copolymer is stabilized with a partially hydrolyzed polyvinyl alcohol.

3. The paper coating slips of claim 1, wherein the aqueous dispersion of the vinyl acetate-ethylene copolymer is stabilized with a partially hydrolyzed polyvinyl alcohol having a degree of hydrolysis of 80 to 95 mol % and a Höppler viscosity in 4% strength aqueous solution of 4 to 30 mPas (Höppler method at 20° C. DIN 53015).

4. The paper coating slip of claim 1, wherein the vinyl acetate-ethylene copolymer comprises one or more copolymers selected from the group consisting of copolymers of vinyl acetate with 1% to 40% by weight of ethylene, copolymers of vinyl acetate with 1% to 40% by weight of ethylene and with 1% to 50% by weight of one or more further comonomers selected from the group consisting of vinyl esters having 3 to 12 C atoms in the carboxylic acid residue, and copolymers of vinyl acetate with 1% to 40% by weight of ethylene and with 1% to 50% by weight of (meth)acrylic esters of unbranched or branched alcohols having 1 to 18 C atoms, the figures in % by weight adding up to 100% by weight in each case.

5. The paper coating slip of claim 1, wherein the vinyl acetate-ethylene copolymer dispersion comprises 1% to 20% by weight of polyvinyl alcohol, based on vinyl acetate-ethylene copolymer.

6. The paper coating slip of claim 1, comprising at least one aqueous dispersion of a styrene-butadiene copolymer or at least one aqueous dispersion of a styrene-acrylic ester copolymer, or comprising a mixture of at least one aqueous dispersion of a styrene-butadiene copolymer and at least one aqueous dispersion of a styrene-acrylic ester copolymer, in each case in combination with at least one aqueous dispersion of a vinyl acetate-ethylene copolymer stabilized with polyvinyl alcohol, in a weight ratio of the styrene-containing copolymers to the vinyl acetate-ethylene copolymer of in each case 50:50 to 95:5 (solid/solid).

7. The paper coating slip of claim 1, wherein the slip further comprises a pigment.

8. A method for producing the paper coating slip of claim 7, comprising mixing the pigment, the binder, water, and also, optionally, further additives.

9. A coated graphics paper or graphics card comprising a coating formed from the paper coating slip claim 1.

10. A method of coating a graphics paper or graphics card, comprising applying to the graphics paper or graphics card the paper coating slip of claim 1.

11. The paper coating slip of claim 7, wherein the fraction of the mixture of aqueous dispersion of the styrene-butadiene copolymer and/or the styrene-acrylic ester copolymer and of the aqueous dispersion of the vinyl acetate-ethylene copolymer stabilized with polyvinyl alcohol is in each case 7 to 20 parts by weight (solid), based on 100 parts by weight of the pigment (solid).
